(19) United States
(12) Patent Application Publication
(10) Pub. No.: US 2015/0120584 A1
(43) Pub. Date: Apr. 30, 2015

(54) METHOD AND SYSTEM FOR VALIDATING RENT DATA FOR A REAL PROPERTY LOCATION

(71) Applicant: MasterCard International Incorporated, Purchase, NY (US)

(72) Inventors: Debashis Ghosh, Charlotte, NC (US); Randy Shuken, Westport, CT (US); Mary Elizabeth Lesbirel, Holmdel, NJ (US)

(73) Assignee: MasterCard International Incorporated, Purchase, NY (US)

(21) Appl. No.: 14/069,193

(22) Filed: Oct. 31, 2013

(51) Int. Cl. G06Q 30/00; G06Q 50/16; G06Q 30/06

(52) U.S. Cl. CPC G06Q 30/018; G06Q 30/0645; G06Q 50/16
USPC 705/317

(57) ABSTRACT

A computer-implemented method for validating rent data associated with a real property location is described. The method is implemented using a validation computing device in communication with a memory. The method includes receiving, at the validation computing device, rent data including a first identifier that identifies the real property location and at least a second identifier that identifies at least one merchant. The method additionally includes receiving, at the validation computing device, historical payment card transaction data associated with the at least one identified merchant, determining, based on the historical payment card transaction data, a last payment card transaction date when the at least one identified merchant was located at the real property location, and determining whether the at least one identified merchant is operating at the real property location based on the last payment card transaction date.

### BACKGROUND

This description relates to validating a merchant doing business at a real property location and, more particularly, to validating rent data associated with a real property location based at least in part on historical payment card transaction data associated with at least one merchant.

In determining whether to invest in a real property location, such as a strip mall or other commercial real estate property, a potential investor generally is interested in whether one or more merchants are actually doing business at the real property location. More specifically, the value of the real property location is based at least in part on whether tenants (e.g., merchants) are located at the real property location and paying rent to the owner of the real property location. Known methods for determining whether merchants are doing business at a real property location involve physically visiting the real property location and determining whether the merchants are physically at the location. In some instances, determining whether merchants are doing business at the real property location includes receiving a list of merchants from a seller of the real property location and verifying that the merchants on the list are actually located at the real property location. However, while physically visiting a real property location may provide visual confirmation that the merchants at least have store fronts at the location, a physical visit may not provide information regarding whether the merchants are actually generating revenue (i.e., doing business) to enable them to pay rent. It would be beneficial to have a system that (a) provides information for validating that one or more merchants are actually doing business at a real property location, and (b) does not require physically visiting the real property location.

### BRIEF DESCRIPTION OF THE DISCLOSURE

In one aspect, a computer-implemented method for validating rent data associated with a real property location is provided. The method is implemented using a validation computing device in communication with a memory. The method includes receiving, at the validation computing device, rent data including a first identifier that identifies the real property location and at least a second identifier that identifies at least one merchant. The method additionally includes receiving, at the validation computing device, historical payment card transaction data associated with the at least one identified merchant, determining, based on the historical payment card transaction data, a last payment card transaction date when the at least one identified merchant was located at the real property location, and determining whether the at least one identified merchant is operating at the real property location based on the last payment card transaction date.

In another aspect, a validation computing device for validating rent data associated with a real property location is provided. The validation computing device incudes a memory device and a processor coupled to the memory device. The validation computing device is configured to receive rent data including a first identifier that identifies the real property location and at least a second identifier that identifies at least one merchant. The validation computing device is additionally configured to receive historical payment card transaction data associated with the at least one identified merchant, determine, based on the historical payment card transaction data, a last payment card transaction date when the at least one identified merchant was located at the real property location, and determine whether the at least one identified merchant is operating at the real property location based on the last payment card transaction date.

In yet another aspect, a computer-readable storage medium having computer-executable instructions embodied thereon is provided. When executed by a validation computing device having at least one processor, the computer-executable instructions cause the validation computing device to receive rent data including a first identifier that identifies a real property location and at least a second identifier that identifies at least one merchant. The computer-executable instructions additionally cause the validation computing device to receive historical payment card transaction data associated with the at least one identified merchant, determine, based on the historical payment card transaction data, a last payment card transaction date when the at least one identified merchant was located at the real property location, and determine whether the at least one identified merchant is operating at the real property location based on the last payment card transaction date.

### BRIEF DESCRIPTION OF THE DRAWINGS

FIGS. 1-8 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is a simplified block diagram of an example validation system including a plurality of computing devices in accordance with one example embodiment of the present disclosure.

FIG. 3 is an expanded block diagram of an example embodiment of a server architecture of the validation system including the plurality of computing devices in accordance with one example embodiment of the present disclosure.

FIG. 4 illustrates an example configuration of a client system shown in FIGS. 2 and 3.

FIG. 5 illustrates an example configuration of a server system shown in FIGS. 2 and 3.

FIG. 6 is a block diagram of an example real property location.

FIG. 7 is a flowchart of an example process for validating rent data associated with the real property location shown in FIG. 6.

FIG. 8 is a diagram of components of one or more example computing devices that may be used in the validation system shown in FIG. 2.

### DETAILED DESCRIPTION OF THE DISCLOSURE

Embodiments of the methods and systems described herein relate to validating that at least one merchant is doing business at a real property location and, more particularly, to validating rent data associated with a real property location based at least in part on historical payment card transaction data associated with at least one merchant. In commercial real estate, the value of a particular piece of real estate (a “real property location”) is based, in part, on the revenue (“cash flow”) that is generated by the real property location. For example, in a strip mall (also referred to as a “shopping center”), the amount of rent paid by one or more merchants doing business at the strip mall is a key factor in determining the value of the strip mall. Accordingly, a potential investor may be interested to obtaining information regarding rent paid by the one or more merchants. The potential investor includes at least one of (i) a potential buyer of the real property; (ii) a bank that is considering making a loan to a potential buyer; and (iii) a bank that is considering refinancing to a current owner of the real property. The potential investor may have a list (i.e., “rent roll”), for example provided by the current owner of the strip mall, of one or more merchants that are purportedly doing business and paying rent at the strip mall. Accordingly, in performing due diligence, the potential investor may wish to obtain validation that rent roll is accurate.

Embodiments of the systems and methods described herein include a computing device that receives rent data including a first identifier that identifies a real property location, and at least a second identifier that identifies at least one merchant. Upon receiving the identifications of the real property location and the at least one merchant, a validation computing device, such as a computing device in communication with a payment network that has access to a database of historical payment card transaction data, provides the date of the last payment card transaction from each identified merchant located at the real property location. Additionally, the validation computing device may provide the date of the first payment card transaction. Additionally, the validation computing device may determine and provide data regarding a frequency of payment card transactions (“payment transaction velocity”) associated with each merchant. Thus, such date(s) could give the potential investor an idea as to whether each merchant is still located at the real property location and running transactions and, in some implementations, when each merchant initially began running such transactions from the real property location.

While the description herein uses a strip mall as an example real property location, it should be understood that the systems and methods described herein would also work for other types of real property locations.

The methods and systems described herein may be implemented using computer programming or engineering techniques including computer software, firmware, hardware or any combination or subset thereof, wherein the technical effect may include at least one of: (a) receiving, at a validation computing device, rent data including a first identifier that identifies a real property location and at least a second identifier that identifies at least one merchant; (b) receiving, at the validation computing device, historical payment card transaction data associated with the at least one identified merchant; (c) determining, based on the historical payment card transaction data, a last payment card transaction date when the at least one identified merchant was located at the real property location; and (d) transmitting, to a client computing device, an indication of the last payment card transaction date associated with the at least one identified merchant.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transaction card can be used as a method of payment for performing a transaction.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

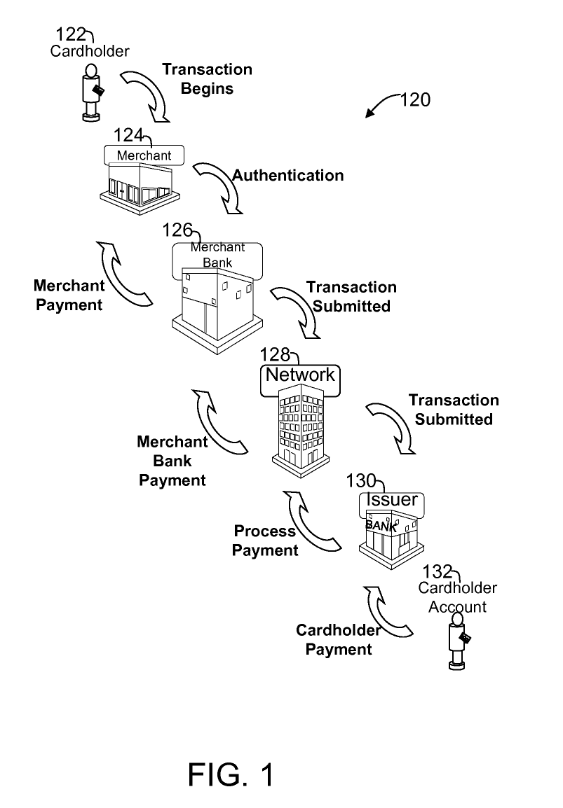

FIG. 1 is a schematic diagram illustrating an example multi-party payment card system 120 for enabling ordinary payment-by-card transactions in which merchants and card issuers do not necessarily have a one-to-one relationship. The present disclosure relates to payment card system 120, such as a credit card payment system using the MasterCard® payment card system payment network 128 (also referred to as an “interchange” or “interchange network”). MasterCard® payment card system payment network 128 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, New York).

In payment card system 120, a financial institution such as an issuer 130 issues a payment account card, such as a credit card account or a debit card account, to a cardholder 122, who uses the payment account card to tender payment for a purchase from a merchant 124. To accept payment with the payment account card, merchant 124 must normally establish an account with a financial institution that is part of the financial payment system. This financial institution is usually called the “merchant bank” or the “acquiring bank” or “acquirer bank” or simply “acquirer”. When a cardholder 122 tenders payment for a purchase with a payment account card (also known as a financial transaction card), merchant 124 requests authorization from acquirer 126 for the amount of the purchase. The request may be performed over the telephone, but is usually performed through the use of a point-of-interaction terminal, which reads the cardholder's account information from the magnetic stripe on the payment account card and communicates electronically with the transaction processing computers of acquirer 126. Alternatively, acquirer 126 may authorize a third party to perform transaction processing on its behalf. In this case, the point-of-interaction terminal will be configured to communicate with the third party. Such a third party is usually called a “merchant processor” or an “acquiring processor.”

Using payment card system payment network 128, the computers of acquirer 126 or the merchant processor will communicate with the computers of issuer 130, to determine whether the cardholder's account 132 is in good standing and whether the purchase is covered by the cardholder's available credit line or account balance. Based on these determinations, the request for authorization will be declined or accepted. If the request is accepted, an authorization code is issued to merchant 124.

When a request for authorization is accepted, the available credit line or available balance of cardholder's account 132 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 124 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer, the cardholder's account 132 is decreased. Normally, a charge is posted immediately to cardholder's account 132. The bankcard association then transmits the approval to the acquiring processor for distribution of goods/services, or information or cash in the case of an ATM.

After a transaction is captured, the transaction is settled between merchant 124, acquirer 126, and issuer 130. Settlement refers to the transfer of financial data or funds between the merchant's account, acquirer 126, and issuer 130 related to the transaction. Usually, transactions are captured and accumulated into a “batch,” which is settled as a group.

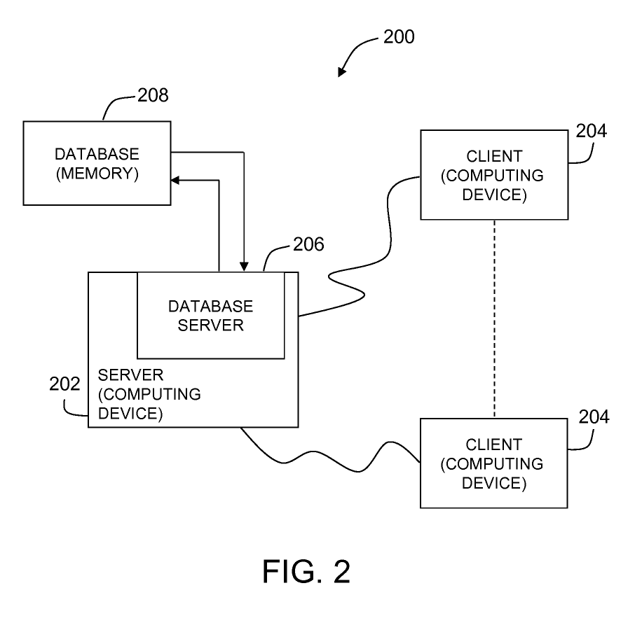

FIG. 2 is a simplified block diagram of an example validation system 200 in accordance with one embodiment of the present disclosure. In the example embodiment, system 200 includes a server system 202 and a plurality of client subsystems, also referred to as client systems 204 or client computing devices, connected to server system 202. In one embodiment, client systems 204 are computers including a web browser, such that server system 202 is accessible to client systems 204 using the Internet. Client systems 204 are interconnected to the Internet through many interfaces including a network, such as a local area network (LAN) and/or a wide area network (WAN), dial-in connections, cable modems, wireless-connections, and special high-speed ISDN lines. Client systems 204 may be any device capable of interconnecting to the Internet including a web-based phone, personal digital assistant (PDA), or other web-connectable equipment. A database server 206 is connected to a database 208 containing information on a variety of matters, as described below in greater detail. In one embodiment, database 208 is stored on server system 202 and may be accessed by potential users at one of client systems 204 by logging onto server system 202 through one of client systems 204. In any alternative embodiment, database 208 is stored remotely from server system 202 and may be non-centralized. Server system 202 could be any type of computing device configured to perform the steps described herein.

As discussed below, historical payment card transaction data from merchants, including merchant account numbers, merchant locations, merchant names, transaction amounts, and transaction dates, is stored within database 208.

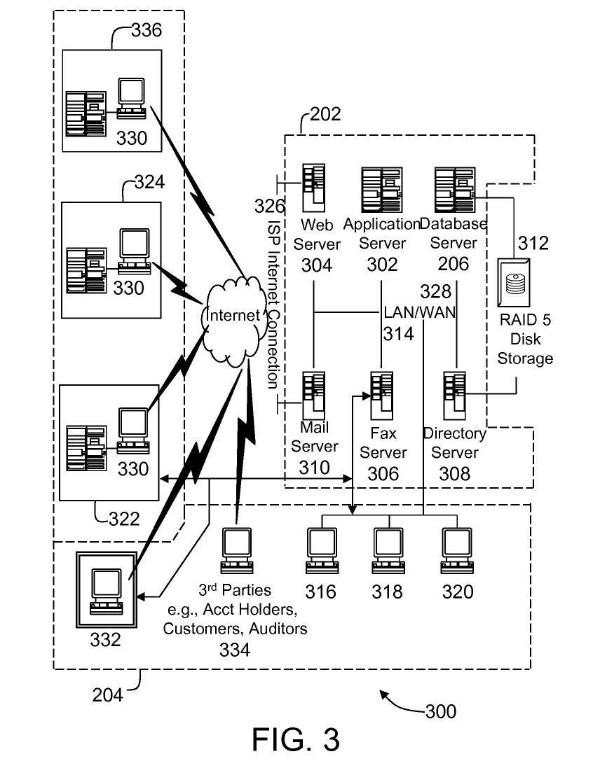

FIG. 3 is an expanded block diagram of an example embodiment of a server architecture of validation system 116 in accordance with one embodiment of the present disclosure. Validation system 116 includes server system 202 and client systems 204. Server system 202 further includes database server 206, an application server 302, a web server 304, a fax server 306, a directory server 308, and a mail server 310. A disk storage unit 312 is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Server system 202 is configured to be communicatively coupled to various entities, including acquirers 322 and issuers 324, and to third parties, e.g., auditors, 334 using an Internet connection 326. Server system 202 is also communicatively coupled with a merchant 336. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

In the example embodiment, any authorized individual or entity having a workstation 330 may access system 300. At least one of the client systems includes a manager workstation 332 located at a remote location. Workstations 330 and 332 include personal computers having a web browser. Also, workstations 330 and 332 are configured to communicate with server system 202. Furthermore, fax server 306 communicates with remotely located client systems, including a client system 332, using a telephone link. Fax server 306 is configured to communicate with other client systems 316, 318, and 320 as well.

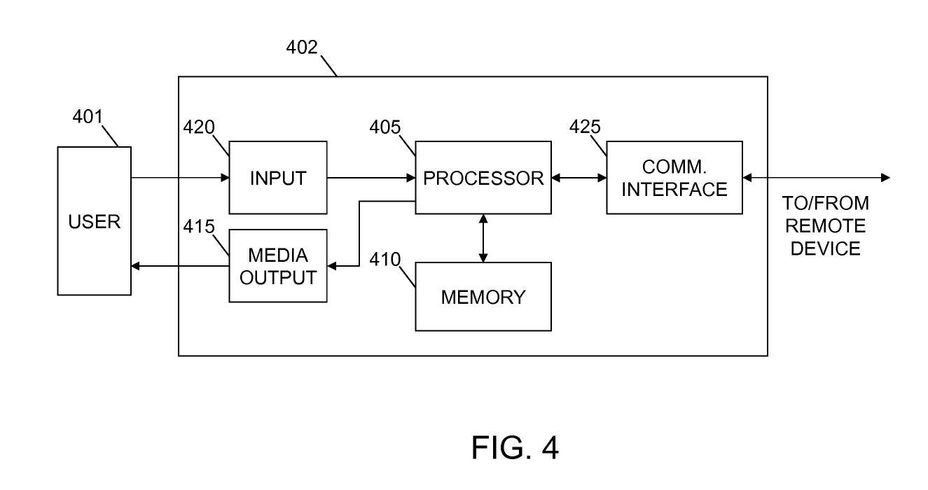

FIG. 4 illustrates an example configuration of a cardholder computing device 402 operated by a cardholder 401. Cardholder computing device 402 may include, but is not limited to, client systems (“client computing devices”) 204, 316, 318, and 320, workstation 330, and manager workstation 332 (shown in FIG. 3).

Cardholder computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

Cardholder computing device 402 also includes at least one media output component 415 for presenting information to cardholder 401. Media output component 415 is any component capable of conveying information to cardholder 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computing device 402 includes an input device 420 for receiving input from cardholder 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

Cardholder computing device 402 may also include a communication interface 425, which is communicatively couplable to a remote device such as server system 202 or a web server operated by a merchant. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface to cardholder 401 via media output component 415 and, optionally, receiving and processing input from input device 420. A user interface may include, among other possibilities, a web browser and client application. Web browsers enable cardholders, such as cardholder 401, to display and interact with media and other information typically embedded on a web page or a website from server system 202 or a web server associated with a merchant. A client application allows cardholder 401 to interact with a server application from server system 202 or a web server associated with a merchant.

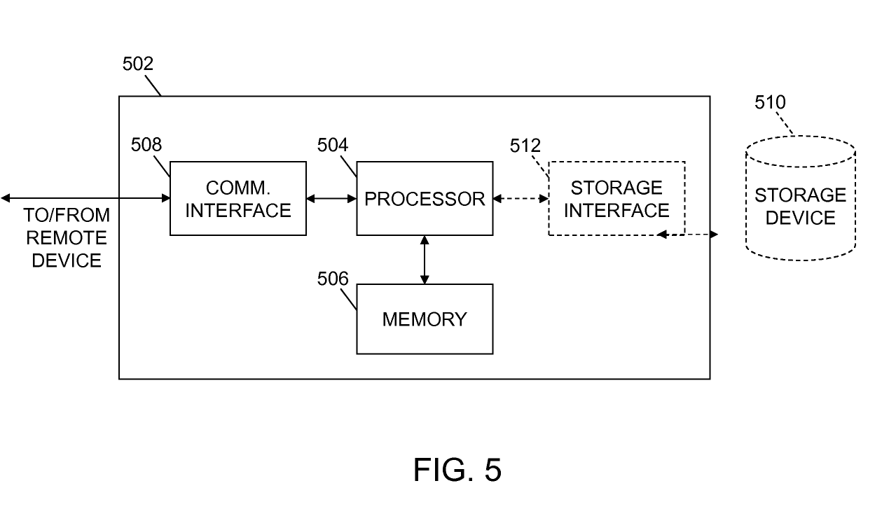

FIG. 5 illustrates an example configuration of a server computing device 502 (“validation computing device”) such as server system 202 (shown in FIGS. 2 and 3). Server computing device 502 may include, but is not limited to, database server 206, application server 302, web server 304, fax server 306, directory server 308, and mail server 310.

Server computing device 502 includes a processor 504 for executing instructions. Instructions may be stored in a memory area 506, for example. Processor 504 may include one or more processing units (e.g., in a multi-core configuration).

Processor 504 is operatively coupled to a communication interface 508 such that server computing device 502 is capable of communicating with a remote device such as cardholder computing device 402 or another server computing device 502. For example, communication interface 508 may receive requests from client systems 204 via the Internet, as illustrated in FIGS. 2 and 3.

Processor 504 may also be operatively coupled to a storage device 510. Storage device 510 is any computer-operated hardware suitable for storing and/or retrieving data. In some embodiments, storage device 510 is integrated in server computing device 502. For example, server computing device 502 may include one or more hard disk drives as storage device 510. In other embodiments, storage device 510 is external to server computing device 502 and may be accessed by a plurality of server computing devices 502. For example, storage device 510 may include multiple storage units such as hard disks or solid state disks in a redundant array of inexpensive disks (RAID) configuration. Storage device 510 may include a storage area network (SAN) and/or a network attached storage (NAS) system.

In some embodiments, processor 504 is operatively coupled to storage device 510 via a storage interface 512. Storage interface 512 is any component capable of providing processor 504 with access to storage device 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 504 with access to storage device 510.

Memory areas 410 and 506 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

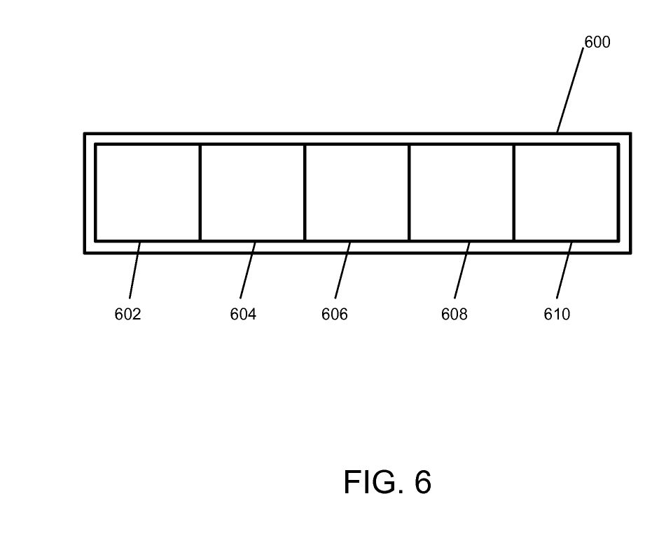

FIG. 6 is a block diagram of an example real property location 600. More specifically, real property location 600 is a commercial real estate property. Even more specifically, real property location 600 is a strip mall that purportedly includes a first merchant 602, a second merchant 604, a third merchant 606, a fourth merchant 608, and a fifth merchant 610. More specifically, a current owner of real property location 600 may have represented to a potential investor in real property location 600 that first merchant 602, second merchant 604, third merchant 606, fourth merchant 608, and fifth merchant 610 are conducting business at real property location 600. Accordingly, each of merchants 602, 604, 606, 608, and 610 purportedly receive payments from one or more cardholders 22 (FIG. 1) for goods and/or services and purportedly pay rent to the owner of real property location 600 using the received payments. At least a portion of such payments are processed through payment network 128 (FIG. 1), as described above. Accordingly, database 208 may contain historical payment card transaction data, including account numbers, locations, and names of merchants 602, 604, 606, 608, and 610, as well as transaction amounts, and transaction dates for each of merchants 602, 604, 606, 608, and 610.

Server system 202 may receive, from client computing device 204, a first identifier (e.g., address) that identifies real property location 600 and a second identifier (e.g., at least one name) that identifies at least one of first merchant 602, second merchant 604, third merchant 606, fourth merchant 608, and fifth merchant 610. For example, if server system 202 receives an identifier of first merchant 602, server system 202 may determine, from the historical payment card transaction data in database 208, a date when first merchant 602 initially received a payment at real property location 600. More specifically, server system 202 may determine the initial (i.e., earliest) date when first merchant 602 (a) had an address that matches real property location 600 and (b) transmitted an authorization request message for a transaction through payment network 128. Likewise, server system 202 may determine a last (i.e., most recent) date when first merchant 602 received a payment at real property location 600. Additionally, server system 202 may determine a number of payments received by first merchant 602 while first merchant 602 was located at real property location 600 and divide the number of payments by the time period between the initial payment date and the last payment date to determine a frequency of payments associated with first merchant 602. More specifically, server system 202 may determine a payment transaction velocity, which is a rate at which first merchant 602 processed payment card transactions over a period of time.

Additionally, server system 202 may determine if and when the location associated with first merchant 602 changed from real property location 600 to a different location, indicating that first merchant 600 has moved away from real property location 600. Accordingly, server system 202 may transmit a notification to client computing device 204 that first merchant 602 has moved to a new location. Further, server system 202 may determine a length of time between the last payment date and a current date, and if the length of time is longer than a predetermined period, for example one month, server system 202 may determine that first merchant 602 has gone out of business. Accordingly, server system 202 may transmit a notification to client computing device 204 that first merchant 602 has gone out of business or that first merchant 602 has not processed a payment within the predetermined time period. Additionally, server system 202 may determine such information for each of second merchant 604, third merchant 606, fourth merchant 608, and fifth merchant 610 if such merchants are identified by the second identifier received from client computing device 204. Furthermore, server system 202 may determine that no such data exists in the historical payment card transaction data for one or more of merchants 602, 604, 606, 608, and 610, and thereafter determine that the one or more merchants may have never conducted business at real property location 600 or may not exist at all.

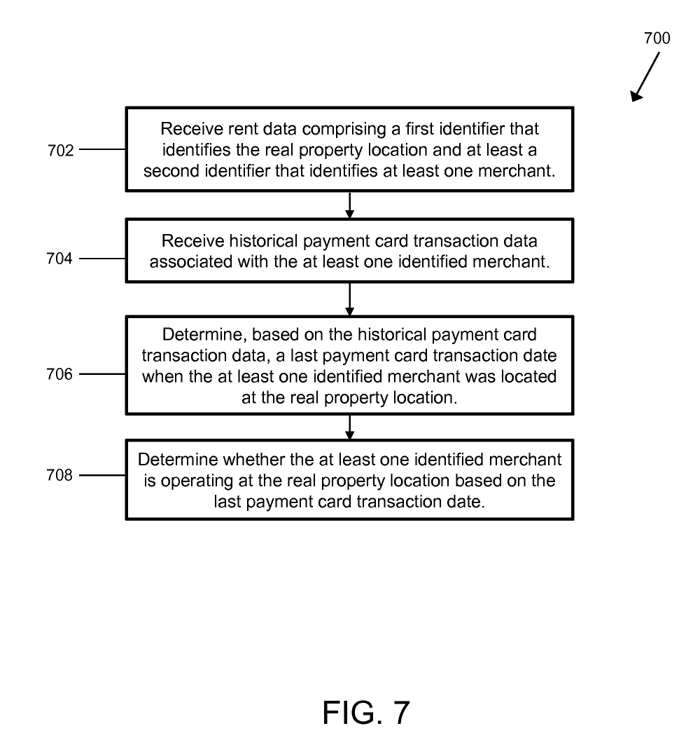

FIG. 7 is a flowchart of an example process 700 for validating rent data associated with real property location 600 (FIG. 6), using validation system 200 shown in FIG. 2. Initially, server system (“validation computing device”) 202 receives 702 rent data including a first identifier that identifies real property location 600 and at least a second identifier that identifies at least one merchant (e.g., first merchant 602, second merchant 604, third merchant 606, fourth merchant 608, and/or fifth merchant 610). The rent data may be transmitted to server system 202 from a client computing device 204 associated with, for example, a potential investor in real property location 600. For example, the first identifier may be a name and/or address of real property location 600. The second identifier may be, for example, a list (“rent roll”) that includes one or more names of merchants. For example, the list may have been provided by a current owner of real estate location 600 to the potential investor in real property location 600. Additionally, server system 202 receives 704 historical payment card transaction data associated with the at least one identified merchant (e.g., first merchant 602, second merchant 604, third merchant 606, fourth merchant 608, and/or fifth merchant 610), if any. For example, server system 202 may query database 208 for historical payment card transaction data associated with the at least one identified merchant, based on the second identifier.

Additionally, server system 202 determines 706, based on the historical payment card transaction data, a last payment card transaction date when the at least one identified merchant (e.g., first merchant 602, second merchant 604, third merchant 606, fourth merchant 608, and/or fifth merchant 610) was located at real property location 600. Additionally, server system 202 determines 708 whether the at least one identified merchant is operating at the real property location based on the last payment card transaction date. Further, server system 202 may transmit the determination of whether the at least one identified merchant is operating at the real property location to client computing device 204. Further, server system 202 may transmit to client computing device 204 an indication of the last payment card transaction date associated with the at least one identified merchant (e.g., first merchant 602, second merchant 604, third merchant 606, fourth merchant 608, and/or fifth merchant 610). More specifically, if the at least one identified merchant is actually multiple identified merchants, server system 202 determines a last payment card transaction date, if any, for each identified merchant and transmits the last payment card transaction date, if any, for each identified merchant to client computing device 204.

If an indicated last payment card transaction date is a predetermined length of time before a current date (i.e., the date that server system 202 performed the query), server system 202 may determine that the identified merchant is no longer doing business at real property location 600 and may transmit an indication to client computing device 204 that the identified merchant appears to no longer be doing business at real property location 600. If no historical payment card transaction data exists in database 208 for the identified merchant, server system 202 may transmit an indication to client computing device 204 that the last payment card transaction date is non-existent. In other words, server system 202 may transmit an indication that the identified merchant does not appear to have ever conducted business at real property location 600.

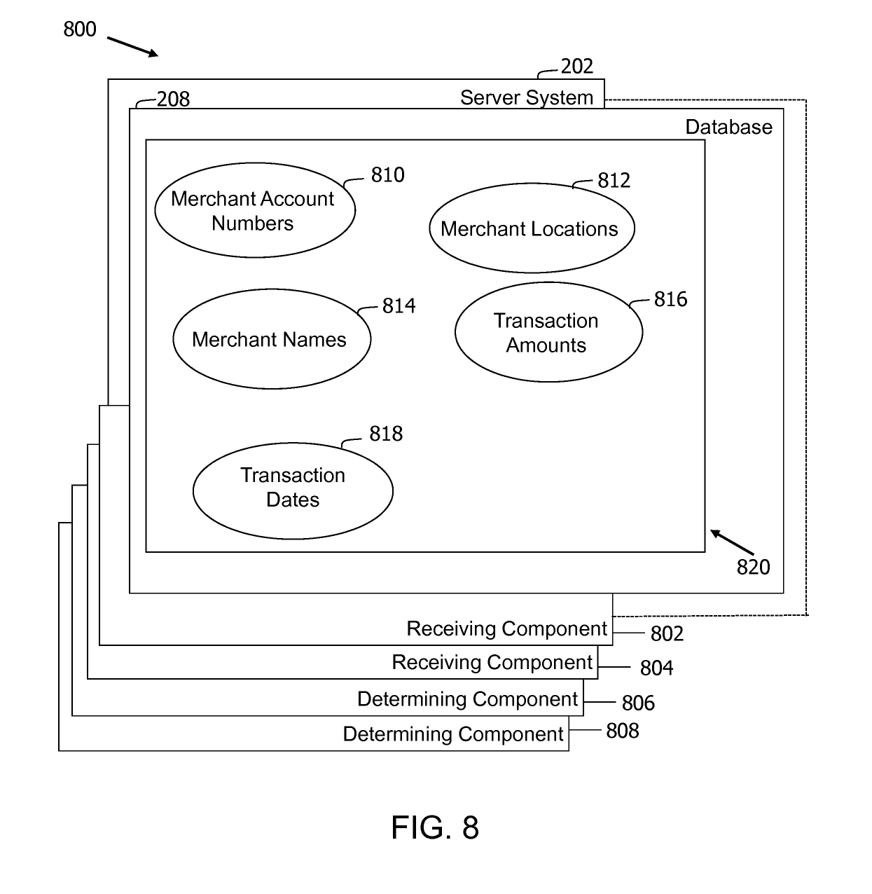

FIG. 8 is a diagram 800 of components of one or more example computing devices, for example, server system 202, that may be used in embodiments of the described systems and methods. FIG. 8 further shows a configuration of database 208 (FIG. 2). Database 208 is coupled to several separate components within server system 202, which perform specific tasks.

Server system 202 includes a receiving component 802 for receiving rent data including a first identifier that identifies a real property location (e.g. real property location 600) and at least a second identifier that identifies at least one merchant (e.g., first merchant 602). Server system 202 also includes a receiving component 804 for receiving historical payment card transaction data associated with the at least one identified merchant (e.g., first merchant 602). Server system 202 additionally includes a determining component 806 for determining, based on the historical payment card transaction data, a last payment card transaction date when the at least one identified merchant (e.g., first merchant 602) was located at the real property location (e.g., real property location 600). Additionally, server system 202 includes a determining component 808 for determining whether the at least one identified merchant is operating at the real property location based on the last payment card transaction date.

In an example embodiment, database 208 is divided into a plurality of sections, including but not limited to, a merchant account numbers section 810, a merchant locations section 812, a merchant names section 814, a transaction amounts section 816, and a transaction dates section 818, all of which may be included within a historical payment card transaction data section 820. These sections within database 208 are interconnected to retrieve and store information in accordance with the functions and processes described above.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 205, 305, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

The above-described embodiments of a method and system of validating rent data for a real property location (a) provide information to potential investors for validating that one or more merchants are actually doing business at a real property location and (b) do not require physically visiting the real property location. As a result, the methods and systems described herein provide a potential investor with more complete and accurate information for validating rent data for a real property location in a more convenient manner than would be provided by conventional systems and methods. It should be understood that certain embodiments of the disclosure may be used to estimate values for real property locations other than strip malls.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for validating rent data associated with a real property location, said method implemented using a validation computing device in communication with a memory, said method comprising:
receiving, at the validation computing device, rent data including a first identifier that identifies the real property location and at least a second identifier that identifies at least one merchant;
receiving, at the validation computing device, historical payment card transaction data associated with the at least one identified merchant;
determining, based on the historical payment card transaction data, a last payment card transaction date when the at least one identified merchant was located at the real property location; and
determining whether the at least one identified merchant is operating at the real property location based on the last payment card transaction date.

2. The computer-implemented method of claim 1, further comprising transmitting, to a client computing device, an indication of the last payment card transaction date associated with the at least one identified merchant.

3. The computer-implemented method of claim 1, further comprising determining an initial payment card transaction date when the at least one identified merchant was located at the real property location.

4. The computer-implemented method of claim 1, wherein the at least one identified merchant includes a first identified merchant and a second identified merchant, said method further comprising determining different last payment card transaction dates for the first identified merchant and the second identified merchant.

5. The computer-implemented method of claim 1, further comprising determining a frequency of payment card transactions associated with the at least one identified merchant.

6. The computer-implemented method of claim 1, further comprising determining that the at least one identified merchant is no longer operating at the real property location based on the last payment card transaction date associated with the at least one identified merchant.

7. The computer-implemented method of claim 6, wherein determining that the at least one identified merchant is no longer operating at the real property location further comprises determining that the at least one identified merchant has not been associated with a payment card transaction within a predetermined time period.

8. The computer-implemented method of claim 6, wherein determining that the at least one identified merchant is no longer operating at the real property location further comprises determining that the at least one identified merchant has moved to a different location.

9. The computer-implemented method of claim 1, further comprising transmitting a notification to the client computing device that the at least one identified merchant has moved to a new location or has not processed a payment within a predetermined time period.

10. The computer-implemented method of claim 1, wherein receiving historical payment card transaction data further comprises receiving the historical payment card transaction data from a payment network.

11. A validation computing device for validating rent data associated with a real property location, the validation computing device comprising a memory device and a processor coupled to said memory device, said validation computing device configured to:
receive rent data including a first identifier that identifies the real property location and at least a second identifier that identifies at least one merchant;
receive historical payment card transaction data associated with the at least one identified merchant;
determine, based on the historical payment card transaction data, a last payment card transaction date when the at least one identified merchant was located at the real property location; and
determine whether the at least one identified merchant is operating at the real property location based on the last payment card transaction date.

12. The validation computing device of claim 11, wherein said validation computing device is further configured to transmit, to a client computing device, an indication of the last payment card transaction date associated with the at least one identified merchant.

13. The validation computing device of claim 11, wherein said validation computing device is further configured to determine an initial payment card transaction date when the at least one identified merchant was located at the real property location.

14. The validation computing device of claim 11, wherein the at least one identified merchant includes a first identified merchant and a second identified merchant, said validation computing device further configured to determine different last payment card transaction dates for the first identified merchant and the second identified merchant.

15. The validation computing device of claim 11, wherein said validation computing device is further configured to determine a frequency of payment card transactions associated with the at least one identified merchant.

16. The validation computing device of claim 11, wherein said validation computing device is further configured to determine that the at least one identified merchant is no longer operating at the real property location based on the last payment card transaction date associated with the at least one identified merchant.

17. The validation computing device of claim 16, wherein said validation computing device is further configured such that determining that the at least one identified merchant is no longer operating at the real property location further comprises determining that the at least one identified merchant has not been associated with a payment card transaction within a predetermined time period.

18. The validation computing device of claim 16, wherein said validation computing device is further configured such that determining that the at least one identified merchant is no longer operating at the real property location further comprises determining that the at least one identified merchant has moved to a different location.

19. The validation computing device of claim 11, wherein said validation computing device is further configured to transmit a notification to the client computing device that the at least one identified merchant has moved to a new location or has not processed a payment within a predetermined time period.

20. A computer-readable storage medium having computer-executable instructions embodied thereon, wherein when executed by a validation computing device having at least one processor, the computer-executable instructions cause the validation computing device to:
receive rent data including a first identifier that identifies a real property location and at least a second identifier that identifies at least one merchant;
receive historical payment card transaction data associated with the at least one identified merchant;
determine, based on the historical payment card transaction data, a last payment card transaction date when the at least one identified merchant was located at the real property location; and
determine whether the at least one identified merchant is operating at the real property location based on the last payment card transaction date.
